(19) United States
(12) Patent Application Publication
(10) Pub. No.: US 2011/0004729 A1
(43) Pub. Date: Jan. 6, 2011

(54) Block Caching for Cache-Coherent Distributed Shared Memory

(75) Inventors: Isam Akkawi, Aptos, CA (US); Najeeb Imran Ansari, San Jose, CA (US); Bryan Chin, San Diago, CA (US); Chetana Nagendra Keltcher, Sunnyvale, CA (US); Krishnan Subramani, San Jose, CA (US); Janakiramanan Vaidyanathan, San Jose, CA (US)

Correspondence Address: Huawei Technologies Co., Ltd., IPR Dept., Building B1-3-A,, Huawei Industrial Base, Bantian, Shenzhen Guangdong, 518129, CN

(73) Assignee: 3Leaf Systems, Inc., Santa Clara, CA (US)

(21) Appl. No.: 11/959,758

(22) Filed: Dec. 19, 2007

(51) Int. Cl. G06F 12/08

(52) U.S. Cl. 711/130; 711/141; 711/E12.038; 711/E12.025

(57) ABSTRACT

Methods, apparatuses, and systems directed to the caching of blocks of lines of memory in a cache-coherent, distributed shared memory system. Block caches used in conjunction with line caches can be used to store more data with less tag memory space compared to the use of line caches alone and can therefore reduce memory requirements. In one particular embodiment, the present invention manages this caching using a DSM-management chip, after the allocation of the blocks by software, such as a hypervisor. An example embodiment provides processing relating to block caches in cache-coherent distributed shared memory.

### CROSS-REFERENCE TO RELATED APPLICATIONS

This application is related to the following commonly-owned U.S. utility patent applications, whose disclosures are incorporated herein by reference in their entirety for all purposes: U.S. patent application Ser. No. 11/668,275, filed on Jan. 29, 2007, entitled “Fast Invalidation for Cache Coherency in Distributed Shared Memory System”; U.S. patent application Ser. No. 11/740,432, filed on Apr. 26, 2007, entitled “Node Identification for Distributed Shared Memory System”; and U.S. patent application Ser. No. 11/758,919, filed on Jun. 6, 2007, entitled “DMA in Distributed Shared Memory System”.

### TECHNICAL FIELD

The present disclosure relates to caches for blocks of physically contiguous lines of shared memory in a cache-coherent distributed computing network.

### BACKGROUND

Symmetric Multiprocessing (SMP) is a multiprocessor system where two or more identical processors are connected, typically by a bus of some sort, to a single shared main memory. Since all the processors share the same memory, the system appears just like a “regular” desktop to the user. SMP systems allow any processor to work on any task no matter where the data for that task is located in memory. With proper operating system support, SMP systems can easily move tasks between processors to balance the workload efficiently.

In a bus-based system, a number of system components are connected by a single shared data path. To make a bus-based system work efficiently, the system ensures that contention for the bus is reduced through the effective use of memory caches in the CPU which exploit the concept, called locality of reference, that a resource that is referenced at one point in time will probably be referenced again sometime in the near future. However, as the number of processors rise, CPU caches fail to provide sufficient reduction in bus contention. Consequently, bus-based SMP systems tend not to comprise large numbers of processors.

Distributed Shared Memory (DSM) is a multiprocessor system that allows for greater scalability, since the processors in the system are connected by a scalable interconnect, such as an InfiniBand® switched fabric communications link, instead of a bus. DSM systems still present a single memory image to the user, but the memory is physically distributed at the hardware level. Typically, each processor has access to a large shared global memory in addition to a limited local memory, which might be used as a component of the large shared global memory and also as a cache for the large shared global memory. Naturally, each processor will access the limited local memory associated with the processor much faster than the large shared global memory associated with other processors. This discrepancy in access time is called non-uniform memory access (NUMA).

A major problem in DSM systems is ensuring that the each processor's memory cache is consistent with each other processor's memory cache. Such consistency is called cache coherence. A statement of the sufficient conditions for cache coherence is as follows: (a) a read by a processor, P, to a location X that follows a write by P to X, with no writes of X by another processor occurring between the write and the read by P, always returns the value written by P; (b) a read by a processor to location X that follows a write by another processor to X returns the written value if the read and write are sufficiently separated and no other writes to X occur between the two accesses; and (c) writes to the same location are serialized so that two writes to the same location by any two processors are seen in the same order by all processors. For example, if the values 1 and then 2 are written to a location, processors do not read the value of the location as 2 and then later read it as 1.

Bus sniffing or bus snooping is a technique for maintaining cache coherence which might be used in a distributed system of computer nodes. This technique requires a cache controller in each node to monitor the bus, waiting for broadcasts which might cause the controller to change the state of its cache of a line of memory. It will be appreciated that a cache line is the smallest unit of memory than can be transferred between main memory and a cache, typically between 8 and 512 bytes. The five states of the MOESI (Modified Owned Exclusive Shared Invalid) coherence protocol have been defined in Volume 2 of the AMD64 Architecture Programmer's Manual as follows:

(a) Invalid—A cache line in the invalid state does not hold a valid copy of the data. Valid copies of the data can be either in main memory or another processor cache.
(b) Exclusive—A cache line in the exclusive state holds the most recent, correct copy of the data. The copy in main memory is also the most recent, correct copy of the data. No other processor holds a copy of the data.
(c) Shared—A cache line in the shared state holds the most recent, correct copy of the data. Other processors in the system may hold copies of the data in the shared state, as well. If no other processor holds it in the owned state, then the copy in main memory is also the most recent.
(d) Modified—A cache line in the modified state holds the most recent, correct copy of the data. The copy in main memory is stale (incorrect), and no other processor holds a copy.
(e) Owned—A cache line in the owned state holds the most recent, correct copy of the data. The owned state is similar to the shared state in that other processors can hold a copy of the most recent, correct data. Unlike the shared state, however, the copy in main memory can be stale (incorrect). Only one processor can hold the data in the owned state-all other processors must hold the data in the shared state.

Read hits do not cause a MOESI state change. Write hits generally cause a MOESI state change into a “modified” state unless the line is already in that state. On a read miss by a node (e.g., a request to load data), the node's cache controller broadcasts, via the bus, a request to read a line and the cache controller for the node with a copy of the line in the state “modified” transitions the line's state to “owned” and sends a copy of the line to the requesting node, which then transitions its line state to “shared”. On a write miss by a node (e.g., a request to store data), the node's cache controller broadcasts, via the bus, a request to read-modify the line. The cache controller for the node with a copy of the line in the “owned” state sends the line to the requesting node and transitions to “invalid” state. The requesting node transitions the line from “invalid” to “modified” state. All other nodes with a “shared” copy of the line transition to “invalid” state. Since bus snooping does not scale well, larger distributed systems tend to use directory-based coherence protocols.

In directory-based protocols, directories are used to keep track of where data, at the granularity of a cache line, is located on a distributed system's nodes. Every request for data (e.g., a read miss) is sent to a directory, which in turn forwards information to the nodes that have cached that data and these nodes then respond with the data. A similar process is used for invalidations on write misses. In home-based protocols, each cache line has its own home node with a corresponding directory located on that node.

To maintain cache coherence in larger distributed systems, additional hardware logic (e.g., a chipset) or software is used to implement a coherence protocol, typically directory-based, chosen in accordance with a data consistency model, such as strict consistency. DSM systems that maintain cache coherence are called cache-coherent NUMA (ccNUMA). In this regard, see B. C. Brock, G. D. Carpenter, E. Chiprout, M. E. Dean, P. L. De Backer, E. N. Elnozahy, H. Franke, M. E. Giampapa, D. Glasco, J. L. Peterson, R. Rajamony, R. Ravindran, F. L. Rawson, R. L. Rockhold, and J. Rubio, Experience With Building a Commodity Intel-based ccNUMA System, IBM Journal of Research and Development, Volume 45, Number 2 (2001), pp. 207-227.

Advanced Micro Devices (AMD) has created a server processor, called Opteron®, which uses the x86 instruction set and which includes a memory controller as part of the processor, rather than as part of a northbridge or memory controller hub (MCH) in a logic chipset. The Opteron memory controller controls a local main memory for the processor. In some configurations, multiple Opteron® processors can use a cache-coherent HyperTransport (ccHT) bus, which is somewhat scalable, to “gluelessly” share their local main memories with each other, though each processor's access to its own local main memory uses a faster connection. One might think of the multiprocessor Opteron system as a hybrid of DSM and SMP systems, insofar as the Opteron system uses a form of ccNUMA with a bus interconnect.

### SUMMARY

In particular embodiments, the present invention provides methods, apparatuses, and systems directed to the caching of blocks of lines of memory in a cache-coherent DSM system. In one particular embodiment, the present invention manages this caching using a DSM-management chip, after the allocation of the blocks by software, such as a hypervisor. Maintaining the state of shared memory lines in blocks achieves, in one implementation, an efficient caching scheme that allows for more line cache states to be tracked with less memory requirements.

### DESCRIPTION OF THE DRAWINGS

FIG. 1 is a diagram showing a DSM system, which system might be used with some embodiments of the present invention.

FIG. 2 is a diagram showing some of the physical and functional components of an example DSM-management logic circuit or chip, which logic circuit might be used as part of a node with some embodiments of the present invention.

FIG. 3 is a diagram showing some of the functional components of an example coherent memory manager (CMM) in a DSM-management chip, which chip might be used as part of a node with some embodiments of the present invention.

FIG. 4 is a diagram showing the formats for a compact export block tag and compact import block tag, which formats might be used with some embodiments of the present invention.

FIG. 5 is a diagram showing the formats for a full export block tag and full import block tag, which formats might be used with some embodiments of the present invention.

FIG. 6 is a diagram showing transitions for allocation and de-allocation of block cache entries, which transitions might be used with some embodiments of the present invention.

FIG. 7 is a diagram showing a flowchart of an example process for allocating a memory block in an export cache, which process might be used with an embodiment of the present invention.

FIG. 8 is a diagram showing a flowchart of an example process for allocating a memory block in an import cache, which process might be used with an embodiment of the present invention.

FIG. 9 is a diagram showing a flowchart of an example process for handling a read command at an import block cache with full import tags, which process might be used with an embodiment of the present invention.

FIG. 10 is a diagram showing a flowchart of an example process for handling a read command at an export block cache with full export tags, which process might be used with an embodiment of the present invention.

FIG. 11 is a diagram showing a flowchart of an example process for handling a read-modify command at an import block cache with full import tags, which process might be used with an embodiment of the present invention.

FIG. 12 is a diagram showing a flowchart of an example process for handling a read-modify command at an export block cache with full export tags, which process might be used with an embodiment of the present invention.

FIG. 13 is a diagram showing a flowchart of an example process for handling a read command's probe at an export block cache, which process might be used with an embodiment of the present invention.

FIG. 14 is a diagram showing a flowchart of an example process for handling a read-modify command's probe at an export block cache, which process might be used with an embodiment of the present invention.

FIG. 15 is a diagram showing a flowchart of an example process for handling a probe for a block sharer at an import block cache, which process might be used with an embodiment of the present invention.

FIG. 16 is a diagram showing a flowchart of an example process for handling a line or replacement at an export cache, which process might be used with an embodiment of the present invention.

FIG. 17 is a diagram showing a flowchart of an example process for handling a line or replacement at an import cache, which process might be used with an embodiment of the present invention.

FIGS. 18A and 18B are state diagrams showing state transitions for a line in import and export block and line caches.

### DESCRIPTION OF EXAMPLE EMBODIMENT(S)

The following example embodiments are described and illustrated in conjunction with apparatuses, methods, and systems which are meant to be examples and illustrative, not limiting in scope.

### A. ccNUMA Network with DSM-Management Chips

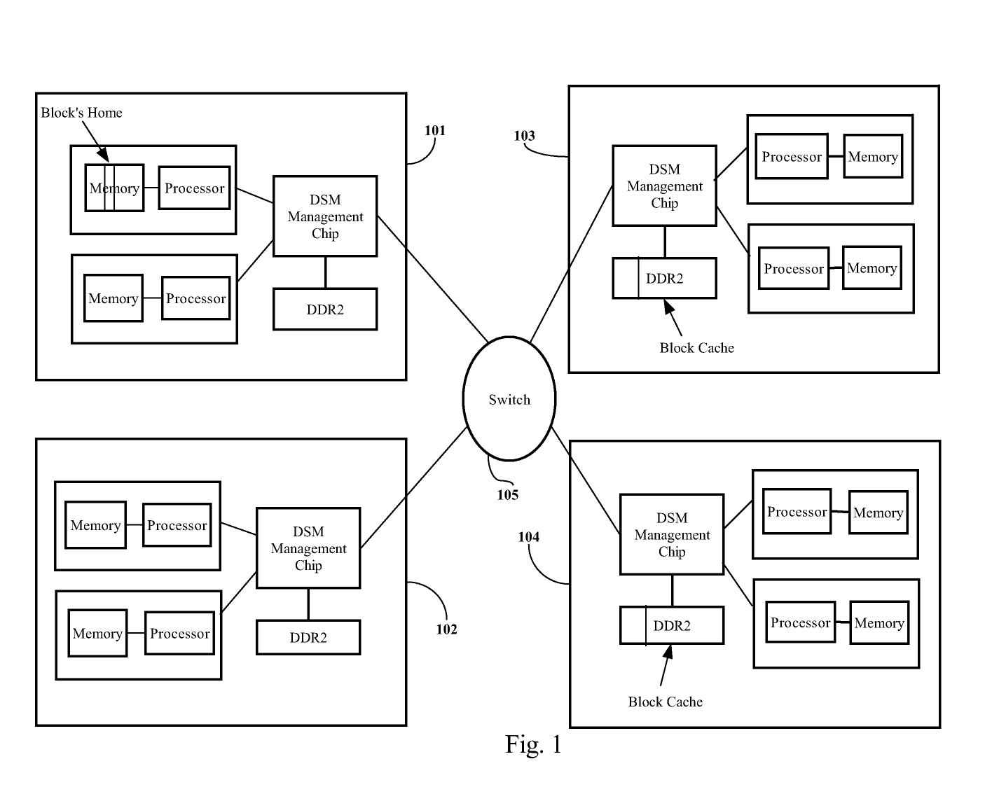

As discussed in the background above, DSM systems connect multiple processors with a scalable interconnect or fabric in such a way that each processor has access to a large shared global memory in addition to a limited local memory, giving rise to non-uniform memory access or NUMA. FIG. 1 is a diagram showing a DSM system, which system might be used with particular embodiments of the invention. In this DSM system, four nodes (labeled 101, 102, 103, and 104) are connected to each other over a switched fabric communications link (labeled 105) such as InfiniBand or Ethernet. Each of the four nodes includes two processors and a DSM-management chip, which DSM-management chip includes memory in the form of DDR2 SDRAM (double-data-rate two synchronous dynamic random access memory). In turn, each processor includes a local main memory connected to the processor. In some particular implementations, the processors might be Opteron processors sold by AMD. The present invention, however, may be implemented in connection with any suitable processors.

As shown in FIG. 1, a block (e.g., a group of physically contiguous lines of memory) has its “home” in the local main memory of one of the processors in node 101. That is to say, this local main memory is where the system's version of the block of memory is stored, regardless of whether there are any cached copies of the block. Such cached copies are shown in the DDR2s for nodes 103 and 104. The DSM-management chip includes hardware logic to make the DSM system cache-coherent (e.g., ccNUMA) when multiple nodes are caching copies of the same block of memory.

### B. Components of a DSM-Management Chip

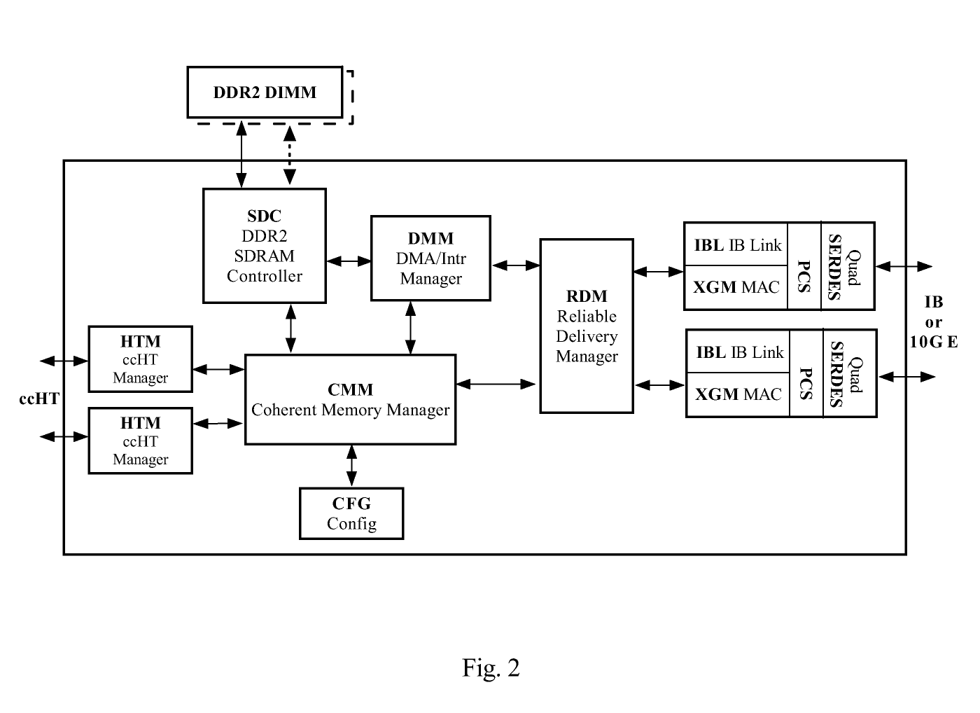

FIG. 2 is diagram showing the physical and functional components of a DSM-management chip, which chip might be used as part of a node with particular embodiments of the invention. The DSM-management chip includes interconnect functionality facilitating communications with one or more processors, which might be Opteron processors offered by Advanced Micro Devices (AMD), Inc., of Sunnyvale, Calif., in some embodiments. As FIG. 2 illustrates, the DSM-management chip includes two HyperTransport Managers (HTM), each of which manages communications to and from a processor over a HT (HyperTransport) bus. More specifically, an HTM provides the PHY and link layer functionality for a cache coherent HT interface such as Opteron's ccHT. The HTM captures all received HT packets in a set of receive queues per interface (e.g., posted/non-posted command, request command, probe command and data) which are consumed by the Coherent Memory Manager (CMM). The HTM also captures packets from the CMM in a similar set of transmit queues per interface and transmits those packets on the HT interface. As a result of the two HTMs, the DSM-management chip becomes a coherent agent with respect to any bus snoops broadcast over the cache-coherent HT bus by a processor's memory controller. Of course, other inter-chip or bus communications protocols might be used in other embodiments of the present invention.

As shown in FIG. 2, the two HTMs are connected to a Coherent Memory Manager (CMM), which provides cache-coherent access to memory for the nodes that are part of the DSM fabric. In addition to interfacing with the Opteron processors through the HTM, the CMM interfaces with the switch fabric, in one implementation, using a reliable protocol implementation, such as the RDM (Reliable Delivery Manager). The processes for block caching described below might be executed by the CMM (e.g., an import block controller and/or an export block controller in the CMM) in particular embodiments. Additionally, the CMM provides interfaces to the HTM for DMA (Direct Memory Access) and configuration (CFG).

The RDM manages the flow of packets across the DSM-management chip's two fabric interface ports. The RDM has two major clients, the CMM and the DMA Manager (DMM), which initiate packets to be transmitted and consume received packets. The RDM ensures reliable end-to-end delivery of packets, in one implementation, using a protocol called Reliable Delivery Protocol (RDP). Of course, other delivery protocols might be used. On the fabric side, the RDM interfaces to the selected link/MAC (XGM for Ethernet, IBL for InfiniBand) for each of the two fabric ports. In particular embodiments, the fabric might connect nodes to other nodes as shown in FIG. 1. In other embodiments, the fabric might also connect nodes to virtual I/O servers. For a further description of virtual I/O servers, see U.S. patent application Ser. No. 11/624,542, entitled “Virtualized Access to I/O Subsystems”, and U.S. patent application Ser. No. 11/624,573, entitled “Virtual Input/Output Server”, both filed on Jan. 18, 2007, which are incorporated herein by reference for all purposes.

The DSM-management chip might also include Ethernet communications functionality. The XGM, in one implementation, provides a 10G Ethernet MAC function, which includes framing, inter-frame gap handling, padding for minimum frame size, Ethernet FCS (CRC) generation and checking, and flow control using PAUSE frames. The XGM supports two link speeds: single data rate XAUI (10 Gbps) and double data rate XAUI (20 Gbps). The DSM-management chip, in one particular implementation, has two instances of the XGM, one for each fabric port. Each XGM instance interfaces to the RDM, on one side, and to the associated PCS, on the other side.

Other link layer functionality may be used to communicate coherence and other traffic of the switch fabric. The IBL provides a standard 4-lane IB link layer function, which includes link initialization, link state machine, CRC generation and checking, and flow control. The IBL block supports two link speeds, single data rate (8 Gbps) and double data rate (16 Gbps), with automatic speed negotiation. The DSM-management chip has two instances of the IBL, one for each fabric port. Each IBL instance interfaces to the RDM, on one side, and to the associated Physical Coding Sub-layer (PCS), on the other side.

The PCS, along with an associated quad-serdes, provides physical layer functionality for a 4-lane InfiniBand SDR/DDR interface, or a 10G/20G Ethernet XAUI/10GBase-CX4 interface. The DSM-management chip has two instances of the PCS, one for each fabric port. Each PCS instance interfaces to the associated IBL and XGM.

The DMM shown in FIG. 2 manages and executes direct memory access (DMA) operations over RDP, interfacing to the CMM block on the host side and the RDM block on the fabric side. For DMA, the DMM interfaces to software through the DmaCB table in memory and the on-chip DMA execution and completion queues. The DMM also handles the sending and receiving of RDP interrupt messages and non-RDP packets, and manages the associated inbound and outbound queues. The DDR2 SDRAM Controller (SDC) attaches to one or more external 240-pin DDR2 SDRAM DIMM, which is actually external to the DMS-management chip, as shown in both FIG. 1 and FIG. 2. The SDC provides SDRAM access for two clients, the CMM and the DMM.

In some embodiments, the DSM-management chip might comprise an application specific integrated circuit (ASIC), whereas in other embodiments the chip might comprise a field-programmable gate array (FPGA). Indeed, the logic encoded in the chip could be implemented in software for DSM systems whose requirements might allow for longer latencies with respect to maintaining cache coherence, DMA, interrupts, etc.

### C. Components of a CMM Module

In some embodiments, the above DSM system allows the creation of a multi-node virtual server, which is a virtual machine consisting of multiple CPUs belonging to two or more nodes. The CMM provides cache-coherent access to memory for the nodes that are part of a virtual server in the DSM system. Also as noted above, the CMM interfaces with the processors through the HTM and with the fabric through the RDM. As described in more detail below, the CMM of the DSM management chip provides facilities for caching blocks of memory to augment line caching and to reduce memory access times that would otherwise be required for memory accesses over the fabric. In particular implementations, a separate process, such as a software application implementing a hypervisor or virtual machine component, executes an algorithm to decide which memory blocks are to be cached, and instructs the CMM to import one or more selected memory blocks from remote nodes, and/or to enable one or more memory blocks for export to the caches of other remote nodes. In certain implementations, the CMM utilizes block-caching data structures that facilitate the sharing and tracking of data corresponding to the block of memory identified in the commands issued by software.

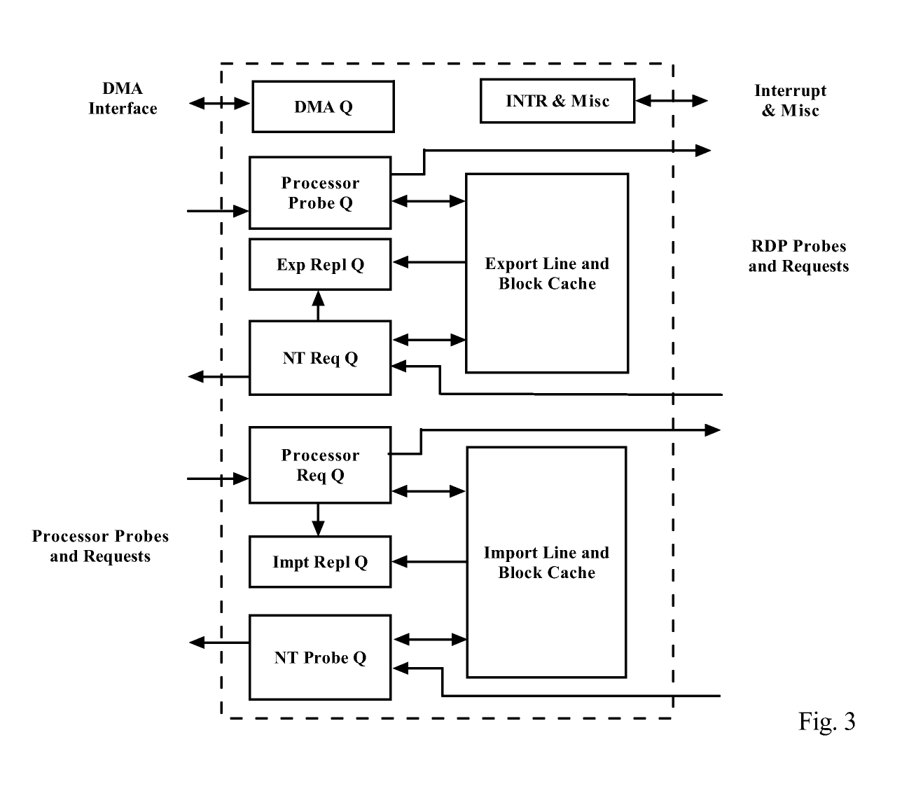

FIG. 3 is a diagram showing the functional components of a CMM, in particular embodiments. As shown in FIG. 3, the CMM may have a number of queues: (1) a Processor Request Queue (Processor Req Q) which holds requests to remote address space from the processors on the CMM's node; (2) an Import Replacement Queue (Impt Repl Q) which holds remote cache blocks that need to be written back to their home node due to capacity limitations on import cache (capacity evictions); (3) a Network Probe Queue (NT Probe Q) which holds network probes from home nodes across the network to the remote address space that is cached on this node; (4) a Processor Probe Queue (Processor Probe Q) which holds probes directed to the node's home (or local) memory address space from the processors on the node; (5) a Network Request Queue (NT Req Q) which holds network requests from remote nodes accessing the node's home (or local) address space; (6) an Export Replacement Queue (Expt Repl Q) which holds home (or local) blocks being recalled due to a capacity limitations on export cache (capacity recalls); (7) a DMA Queue (DMA Q) which interfaces the DMM with the processors' bus; and (8) an Interrupt and Miscellaneous Queue (INTR & Misc Q) which interfaces the Interrupt Register Access and other miscellaneous requests with the processors' bus.

As discussed in more detail below, the CMM maintains one or more data structures operative to track the lines and blocks of memory that have been imported to and exported from a given node. In the implementation shown in FIG. 3, the CMM includes an Export Line and Block Cache which might hold cached export tags and an Import Line and Block Cache which might hold import tags and cached memory blocks, in some embodiments. In other embodiments, the cached memory blocks might be held in the DDR2 (RAM) of the DSM-management chip in addition to the cached line data.

### D. Tags for Block Caching

When a node requests cacheable data which is resident on another node, the node will request a cache-line from the home node of that data. When the data line is returned to the requesting node for use by one of the node's processors, the data line will also be cached on the local node. In some embodiments, the DSM-management chip will monitor probes on the home node for data that has been exported to other nodes, as well as local node accesses to remote memory, to maintain cache coherency between all the nodes. For this monitoring, particular embodiments of the DSM-management chip maintain two sets of cache tags: (a) a set of export tags that tracks the local memory which was exported to other nodes; and (b) a set of import tags that tracks the remote memory which was imported from other nodes.

To augment cache size (performance) and reduce on-chip tag requirements (cost), a portion of the on-chip tag is used to track lines (e.g., at a 64-byte resolution such as is used for cache lines by Opteron) and a portion is used to track blocks of physically contiguous lines (e.g., at a 4096-byte resolution such as is used for memory pages by Linux). Here it will be appreciated that block caching augments line caching, by allowing the caching of a larger amount of memory with a smaller amount of tag, in relative terms. Further, block caching allows two or more nodes to designate a block as shared, which, in turn, allows each sharing node to have quicker read access to the shared block.

In some embodiments, the tracking of line states in a block is accomplished by having state bits for each line in the block, which is kept in the block cache tag. In other embodiments, a hybrid approach can be used, where only part (or none) of the line state in a block, is kept in the block tag, and the line cache tag state is used to augment the block cache state.

In particular embodiments, only one block state bit is needed to indicate that the lines in that block are valid (and their state is Shared) or not. The tracking of the cache-coherence states of deviant lines is accomplished by expanding the line tag state to include a “block line invalid” state for import cache and “block line Remote Invalid” for the export cache. When a tag read returns a block hit and a line hit, the line state takes precedence. This “block line invalid” in import cache corresponds to the normal miss in traditional line caching (correspondingly “block line Remote Invalid” is the normal miss case for export cache). Also in traditional line caching, an invalid entry or a miss means that the line does not exist in the cache. However, in the case of the line tag expanded as above, if the line is in a block cache, such a state indicates that the line is in the shared state. Similarly if a line in “block line invalid” or “block line Remote Invalid” state needs to be replaced, the line will need to be updated (made Shared) first in the block data cache.

In particular embodiments, in addition to the block valid state bit, an additional state bit per line in the block cache tag can be used in place of the “block line invalid” line state for import cache and “block line Remote Invalid” for export cache. Now when the line cache state is Invalid (i.e. miss), the line in the block cache can be in one of two states depending on this bit, Shared or Invalid for import cache, and Shared or Remote Invalid for export cache. As described herein, using a block cache data structure to track the state of multiple lines saves memory resources. Further, using one bit per line, rather than 2 or more bits, to keep track of a line's state represents a further saving of resources. In addition, the engineering or design choices for the configuration of import and export data structures can be made independently. That is, the number of bits used to represent the state of various lines in, and the structure of, the export cache is independent of the configuration of the import cache.

In particular embodiments, the relationship between block caching and line caching is that line caching takes precedence over block caching when it comes to cache-coherence state. That is, for a given cache line, if a valid state exists in the line cache and the line's block is in the block cache, the cache-coherence state in the line cache takes precedence over the cache-coherence state of the block. It will be appreciated that individual lines in a block can deviate from the block's cache-coherence state, without the need to modify the cache-coherence state of the block, so long as the cache-coherence states of the deviant lines are tracked in some way.

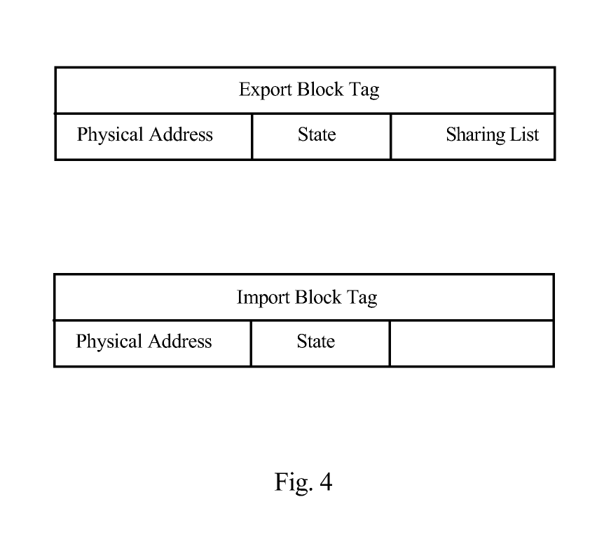

FIG. 4 is a diagram showing the formats for a compact export block tag and compact import block tag, which formats might be used with some embodiments of the present invention. As shown in FIG. 4, both the export and import block tags might include a field called “Physical Address” for an address in physical memory and a field called “State” for a block state, which might be “Shared” or “Invalid” (e.g., a single bit) in some embodiments. The export block tag might also include a field called “Sharing List” for a list (e.g., a one-hot representation or a list of binary numbers) of the nodes to which the memory block has been exported by the home node on which the memory block resides. Of course, such a list would not be needed in an import block tag. It will be appreciated that the compact export and compact import block tags correspond to the case where the tracking of deviant lines that are “invalid” is accomplished by expanding the line tag, if additional bits are needed, to include “block line invalid” or “block line Remote Invalid” states.

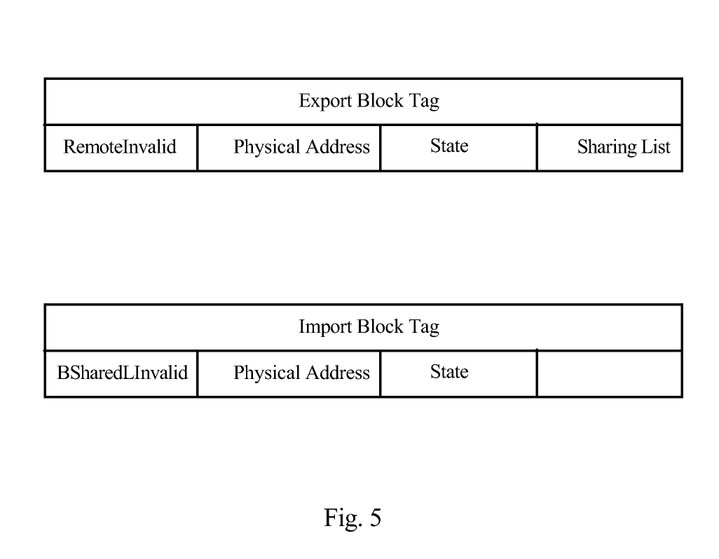

FIG. 5 is a diagram showing the formats for a full export block tag and full import block tag, which formats might be used with some embodiments of the present invention. The full export block tag and the full import block tag include all of the fields in the compact export block tag and the compact import block tag, respectively. Additionally, each of the full block tags has a field that might contain a pointer (e.g., an abbreviated physical address) to a location in the DSM-management chip's memory, which location stores a “valid” bit for each of the lines in a shared block. Alternatively, the full block “valid” bit (RemoteInvalid or BSharedLInvalid) can be stored in external memory in a fixed memory location. This additional field is called RemoteInvalid in an exported block tag and BSharedLInvalid in an imported block tag. As mentioned above, when compact block tags are used, the information in these additional fields might be stored in line tags.

In some embodiments, the use of summary bits in the full block tag fields instead of the full RemoteInvalid or BSharedLInvalid bits might allow the DSM-management chip to avoid looking in memory for all RemoteInvalid or BSharedLInvalid bits. For example, in an implementation where a block consists of 64 lines, eight summary bits can be used, where each bit might be the logical OR of eight RemoteInvalid or BSharedLInvalid bits stored in memory. That is, the 64 lines in a block might be divided into eight groups, each of which contains eight lines. Then each summary bit might represent one of these groups. If “OR” is used to compute the summary bits, then if a given summary bit is 0, then there will be no need to get the full block “valid” bits from the external memory. Of course, the formats shown in FIGS. 4 and 5 are merely example formats whose fields might vary as to both content and/or size in other embodiments.

### E. Allocation and Management of Block Caching

In some embodiments, line caching is allocated and managed in hardware (e.g., the DSM-management chip), while block caching is allocated by software and managed in hardware. In other implementations, block caching can be allocated in hardware as well. With respect to block caching, a process implemented in hardware or software might tell the DSM-management chip which block to allocate/de-allocate (e.g., on the basis of utilization statistics) through registers inside the DSM-management chip that control an allocation/de-allocation engine. Additionally, in some embodiments, the DSM-management chip might provide some bits to assist the process in gathering the statistics on block utilization (e.g., identifying “hot” remote blocks that are accessed regularly and often enough to justify a local-cache copy). So for example, a block tag might include one bit for a write hit (e.g., a RdMod hit) and one bit for a read hit (e.g., a RdBlk hit), which are set when a block is hit on a RdMod or RdBlk, respectively. Subsequently, such a bit might be cleared on an explicit command to the register space. Here, it will be appreciated that RdMod and RdBlk are commands used with AMD's ccHT, as explained in U.S. Pat. No. 6,490,661 (incorporated by reference herein), which commands might be aggregated to form pseudo-operations.

In some embodiments, a block cache in the DSM system is an n-way (e.g., 4-way) set associative cache. A hypervisor, in a particular embodiment, might configure the base physical address of the block cache in the DSM-management chip during initialization. When a decision is made to cache a block, the hypervisor might choose an available way on both the home node and the remote node to use and inform the DSM-management chip of the remote physical address to be cached and the way into which it should be placed. The hypervisor might also handle the removal of a memory block from the cache (eviction), if the hypervisor determines that (a) the block is no longer hot, or (b) there is a hotter block to be brought in and all n ways of that index are full. The process of bringing the block data into the cache (allocation) or removing the data from the cache (de-allocation) will be performed by hardware and will be transparent to a running DSM system so the block data will remain accessible throughout this process.

In some embodiments, the hypervisor might use a Block Allocation Control Block (BACB) which resides on a DSM-management chip for communicating which cache blocks to be allocated or de-allocated in the cache block memory space. Allocating a cache block results in making all lines of the corresponding block being block shared, while de-allocating a cache block results in all lines of the corresponding block being invalid. The BACB might contain the following fields: (a) the physical address of the block to be allocated; (b) the home node export tag way into which this entry is to be loaded; (c) the local node import tag way into which this entry is to be loaded; (d) the operation requested (allocate/de-allocate); (e) the cache state to bring the block in; (f) an Activate bit which is set when the DSM-management chip starts the allocation/de-allocation operation and reset when the operation is complete; and (g) status bits to indicate the success/failure of the operation, which bits will get cleared when the “Activate” bit is set, and which will be valid when the DSM-management chip resets the “Activate” bit. In a particular embodiment, there will be a limited number (e.g., four) of BACBs and the hypervisor will have to wait for a free (e.g., not active) BACB if all the BACBs are active.

In some embodiments, a block in a block cache has two main states (Invalid and Shared, which might be represented by a single bit per block, in some embodiments) and a hybrid state, where the state of individual lines within a valid block are tracked with a hybrid state determined by reference to cache line state in the block tag and line tag. As noted above, the hybrid state applies to lines within the block and is different for the export and import block caches. An export block cache line within a valid block might be Modified (M), Shared (S), or Owned (O) with nodes that do not match the block sharing list, as well as RemoteInvalid (locally modified on export) or else would be shared by all block sharers in the block sharing list. An import block cache line within a valid block might be Modified, BSharedLInvalid, or Shared. If a block is invalid, the normal MOSI line states are used for a given cache line. Software controls (e.g., through the BACB) the transition from Invalid to Shared and the transition from Shared to Invalid. Hardware manages the transition to RemoteInvalid (for the export tag), as well as transitions between hybrid states for a line (M/O/S/S(all block sharers)/RemoteInvalid) and the transition to BSharedLInvalid (for the import tag), and transitions between hybrid states for a line (M/O/S/BSharedLInvalid). Stores to memory from a home node cause transitions for the block cache line to RemoteInvalid in the export block cache and to BSharedLInvalid in the import block cache. Stores to memory from any remote node cause transitions to BSharedLInvalid in the import block cache on nodes that are sharing the block cache line, other than the home node, where the transition is to Modified in the export line cache, and in the import line cache of the remote requesting node which also transitions to Modified.

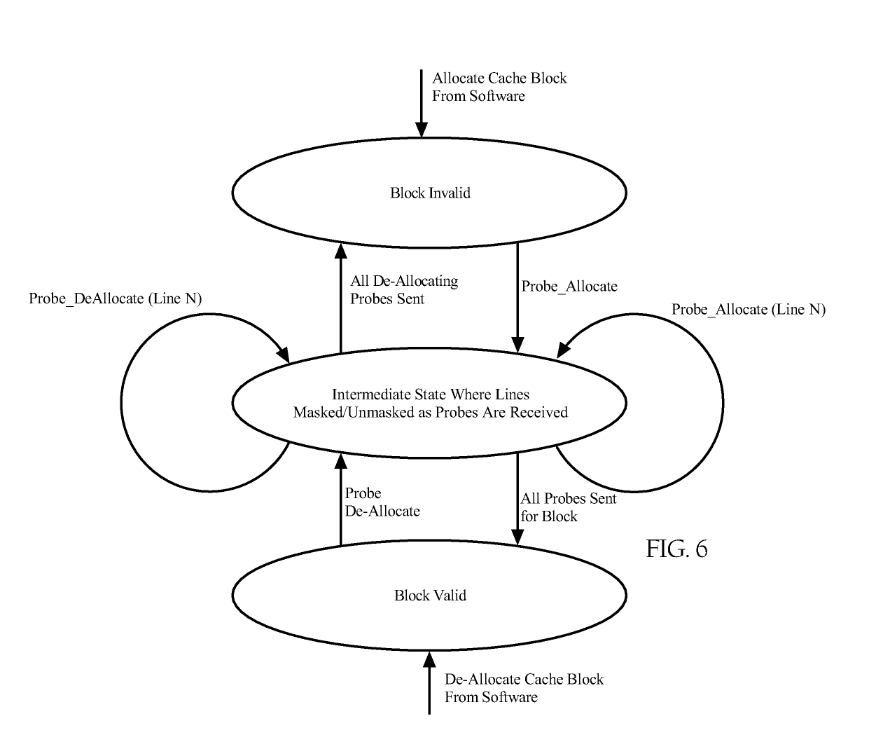

FIG. 6 is a state diagram showing transitions of block cache entry according to one possible implementation of the invention. As FIG. 6 illustrates, the decision to allocate or de-allocate a cache block entry is made, in one embodiment, by a software process. When a command to allocate a block cache entry is received, the home node transmits invalidating probes for each line of the block (Probe_Allocate (Line N)) to one or more identified block sharers. The initial state of the entire block in either an export or import block cache is invalid, and transitions to an intermediate state where individual lines corresponding to the block are unmasked as invalidating probes are transmitted or received (depending on the role of the node). When invalidating probes for all lines have been received, the state of the entire block is now valid. Similarly, when a de-allocate command is received, the home node transmits de-allocating probes for all lines (Probe_DeAllocate (Line N)), causing the lines to be masked. When all de-allocating probes have been transmitted, the state of the block transitions to invalid.

### F. Processes for Block Caching

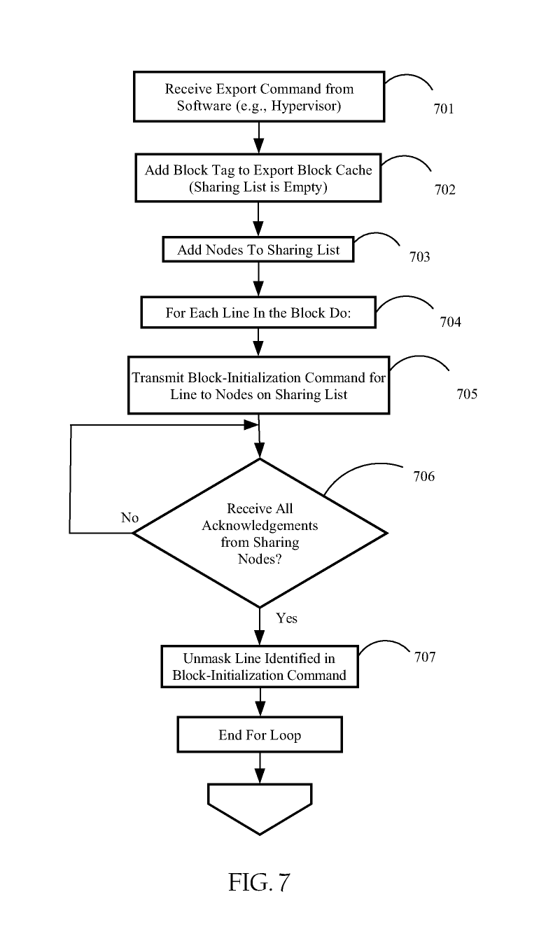

FIG. 7 is a diagram showing a flowchart of an example process for allocating a memory block in an export cache, which process might be used with an embodiment of the present invention. In the process's first step 701, the export block controller (e.g., in the CMM) receives an export command for a memory block from software (e.g., a hypervisor). In step 702, the export block controller adds a tag for the block to the export block cache, which tag has an empty sharing list. Then in step 703, the export block controller adds nodes (e.g., the nodes identified in the export command) to the tag's sharing list. In step 704, the export block controller creates a sequential iteration over each line in the block to be exported. In step 705, the first step of the iteration, the export block controller transmits a block-initialization command for a line to the nodes on the sharing list. Then in step 706, the export block controller does a busy wait until it receives a corresponding acknowledgement from the other nodes. Once all the other nodes have acknowledged the block-initialization command, the export block controller unmasks the line identified in the command, in step 707. This is the last step of the iteration and the last step of the process.

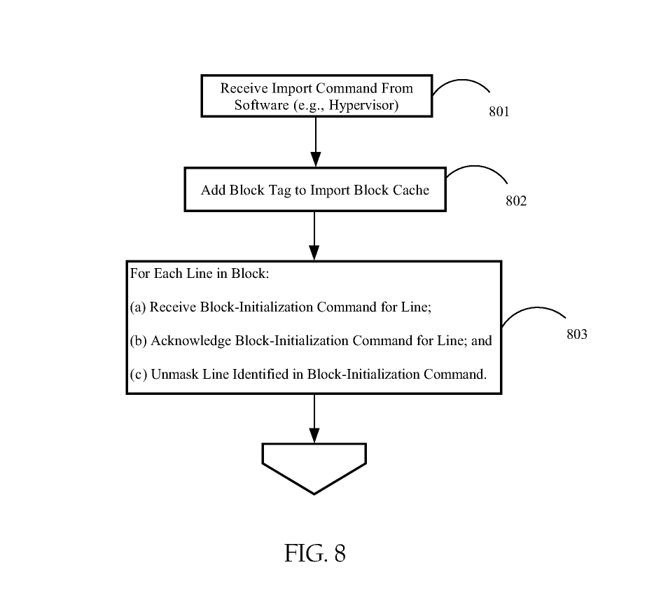

FIG. 8 is a diagram showing a flowchart of an example process for allocating a memory block in an import cache, which process might be used with an embodiment of the present invention. This process is complementary to the process shown in FIG. 7. In step 801, the first step of the process shown in FIG. 8, the import block controller (e.g., in the CMM) receives an import command for a memory block from software (e.g., a hypervisor). Then in step 802, the import block controller adds a tag for the block to the import block cache. In step 803, the import block controller: (a) receives an initialization command for a line in the block from the export block controller in the home node's DSM-management chip; (b) sends an acknowledgement back to the export block controller; and (c) unmasks the line identified in the block-initialization command. In the ordinary course (e.g., if there is no error condition), the import block controller will repeat the operations shown in step 803 sequentially for each line of the block to be imported. It will be appreciated that step 803 in FIG. 8 corresponds to steps 705 and 706 in FIG. 7.

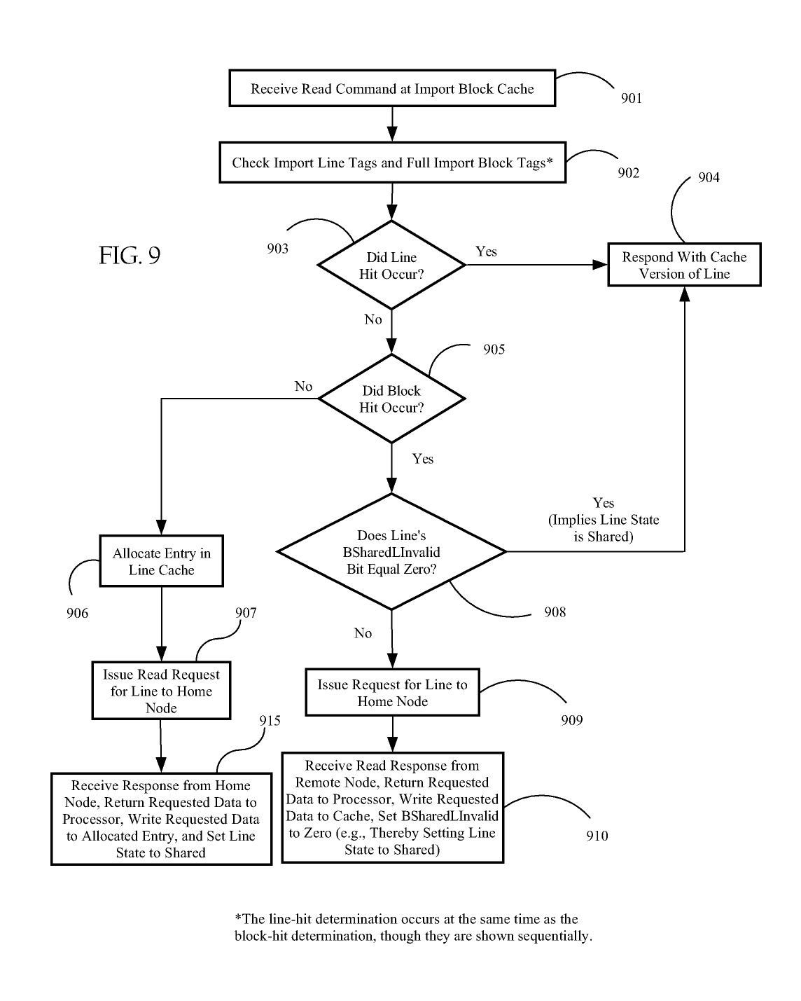

FIG. 9 is a diagram showing a flowchart of an example process for handling a read command (e.g., RdBlk) at an import block cache with full import tags, which process might be used with an embodiment of the present invention. In the process's first step 901, an import block controller receives a read command and, in step 902, checks the import line tags and the full import block tags to make the determinations shown in steps 903 and 905. As noted in FIG. 9, those two determinations can occur simultaneously to save time, though they are shown sequentially in the figure. In step 903, the import block controller determines whether a line hit occurred. A line hit implies that the line state is Modified or Owned, as well as Shared if that implies a block cache miss. If a line hit occurs, the import block controller goes to step 904 and responds to the read command with the cache version of the line. If a line hit does not occur, the import block controller goes to step 905 and determines whether a block hit has occurred. As indicated earlier, a block hit implies that all the lines in the block are in a Shared state. If a block hit does not occur, the import block controller goes to step 906 and allocates an entry in the line cache for the line and then goes to step 907. In step 907, the import block controller issues a read request for the line to the home node. When a response from the home node is received, the import block controller returns the requested data to the processor, writes the requested data to the allocated entry, and sets the line state to Shared (915). Otherwise, if a block hit occurs in step 905, the import block controller goes to step 908 and makes a further determination as to whether the line's BSharedLInvalid bit is equal to zero (e.g., clear or not set, which implies the line state is Shared, rather than Invalid). If that bit is equal to zero, the import block controller proceeds to step 904 and responds with the cache version of the line. Otherwise, if the bit is set, the import block controller proceeds to step 909, issues a request for the line to the line's home node, and then proceeds to step 910. In step 910, the import block controller receives a read response from the responding remote node, returns the requested data to the processor, writes the requested data to the cache, sets the line's BSharedLInvalid bit to zero (e.g., thereby setting the line state to Shared).

As noted above, some embodiments use compact block tags rather than full block tags. In such embodiments, many of the steps shown in FIG. 9 remain the same. However, there would be no step 908, since the line tag includes a valid entry with an invalid state which can be checked during the check for a line hit in step 903. Similarly, in embodiments with compact block tags, step 910 would differ from that shown insofar as there would be no BSharedLInvalid bit to be set to zero when setting the state to Shared (in that case, the line state for the line in the line cache would be set to Invalid).

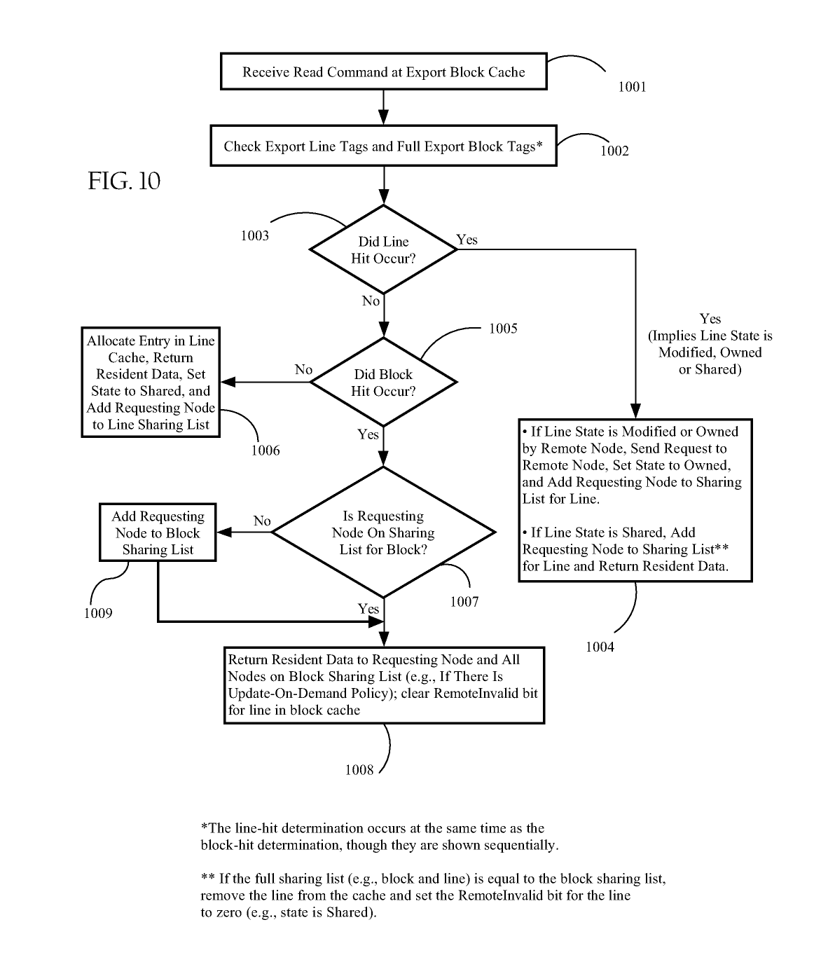

FIG. 10 is a diagram showing a flowchart of an example process for handling a read command (e.g., from a remote node) at an export block cache with full export tags, which process might be used with an embodiment of the present invention. Here it will be appreciated that the export block controller's node is the home node. In the process's first step 1001, an export block controller receives a read command and, in step 1002, checks the export line tags and the full export block tags to make the determinations shown in steps 1003 and 1005. As noted in FIG. 10, those two determinations occur at the same time, though they are shown sequentially in the figure. In step 1003, the export block controller determines whether a line hit occurred. A line hit implies that the line state is Modified, Owned, or Shared. If a line hit occurs, the export block controller goes to step 1004. In step 1004, if the line state is either Modified or Owned by a remote node, the export block controller sends a probe to the remote node that owns the line to forward a copy of the data to the requesting node, sets the state to Owned, and adds the requesting node to the sharing list for the line. In step 1004, if the line state is Shared, the export block controller adds the requesting node to the sharing list for the line and then returns the requested data to the requesting node. If a line hit does not occur, the export block controller goes to step 1005 and determines whether a block hit has occurred. As indicated above, a block hit and a line miss implies that all the lines in the block are in a Shared state as to the sharing nodes of the block sharing list, rather than an Invalid state. If a block hit does not occur, the export block controller goes to step 1006, where the export block controller allocates an entry in the line cache for the line, returns the resident data, sets the state to Shared, and adds the requesting node to the sharing list for the line. If a block hit occurs, the export block controller goes to step 1007, where the export block controller determines whether the requesting node is on the sharing list for the block. If not, the export block controller adds the requesting node to the sharing list for the block (1009). If so, the export block controller goes to step 1008, where the export block controller returns the resident data to the requesting node and all nodes on the block's sharing list (e.g., if there is an update-on-demand policy) and clears the RemoteInvalid bit for the line in the block cache. If RemoteInvalid is set to one, the export block controller returns the data to the requesting node, and transmits a pushBlk command to all other nodes of the block sharing list and sets RemoteInvalid to zero.

As noted in FIG. 10, if a line sharing list is equal to the block sharing list in step 1004, the export block controller may remove the line from the line cache and sets the line's RemoteInvalid bit in the cache block to zero (e.g., state is Shared). Here it will be appreciated that it is possible for the line sharing list to include line sharers who are not block sharers. The same or similar (e.g., de-allocating the line cache tag entry, setting it to invalid) operation might also occur in step 1004 if the line's state goes to Shared and the full sharing list is equal to the block sharing list. (In embodiments that use compact block tags, these operations would be the same, except insofar as there is no RemoteInvalid bit to be set or cleared.) In addition, the case of RemoteInvalid equaling one would be covered in the line cache. Consequently, when the DSM system is in its steady-state, the export block cache will consist mostly of export block tags in a Shared (rather than Invalid) state without corresponding line tags. It will be appreciated that this steady-state allows the DSM system to use less tag memory than other systems that employ cache line tags without cache block tags.

As noted with respect to step 1008, the export block controller might return the requested lines to other nodes, if the update policy is update-on-demand. Such a policy generates updates to all sharers when a requester issues a read command. Other update policies that might be used here are lazy update on demand and update on replacement. In the former policy, when a requesting sharer issues a read command, only that sharer receives an update. In update on replacement, updates are generated when a line cache entry is replaced due to a capacity miss in the export cache.

It will be appreciated that update-on-demand can occur when any remote sharer requests a cache line that is part of a shared block which is not up-to-date. The remote requestor does not have to be a block sharer. Update-on-demand has two phases: (1) bring to home; and (2) update. The first phase requires that remotely Owned or Modified data be written to the memory of the home node. In some embodiments that use the update-on-demand policy, the line's state might be set to Shared rather than Owned, upon receipt of the remotely Owned or Modified data.

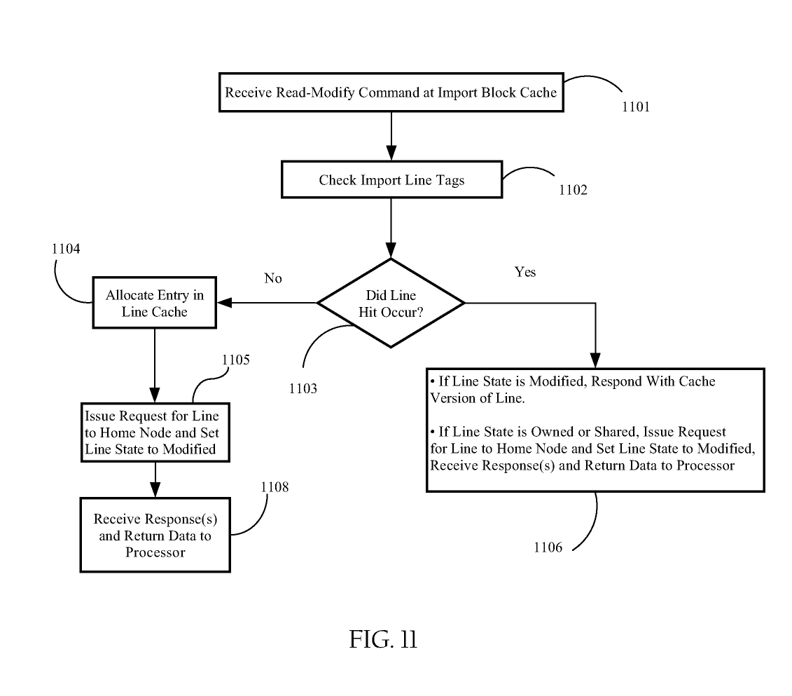

FIG. 11 is a diagram showing a flowchart of an example process for handling a read-modify command (e.g., RdMod) at an import block cache with full import tags, which process might be used with an embodiment of the present invention. In the process's first step 1101, an import block controller receives a read with intent to modify (RdMod) command and, in step 1102, checks the import line tags to make the determination shown in step 1103. In that step, the import block controller determines whether a line hit occurred. A line hit implies that the line state is Modified, Owned, or Shared. If a line hit occurs, the import block controller goes to step 1106 and (a) responds with the cache version of the line, if the line state is Modified, or (b) issues a request for the line to the line's home node, sets the line state to Modified, if the line state is Owned or Shared, and returns the data to the processor when a response is received. Otherwise, if a line hit does not occur, the import block controller goes to step 1104 and allocates an entry in the line cache. Then, in step 1105, the import block controller issues a request for the line to the line's home node and sets the line state to Modified. In step 1108, the import block controller returns data to the processor when responses are received.

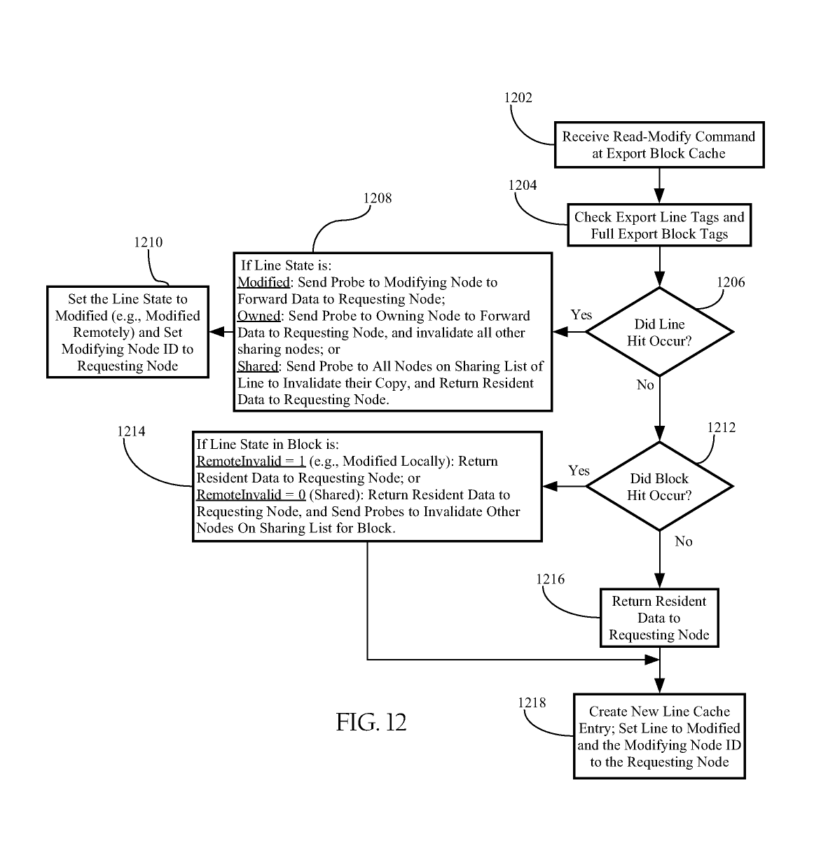

FIG. 12 is a diagram showing a flowchart of an example process for handling a read-modify command (e.g., from a remote node) at an export block cache with full export tags, which process might be used with an embodiment of the present invention. It will be appreciated here that the export block controller's node is the home node. In the process's first step 1202, an export block controller receives a read-modify command and, in step 1204, checks the export line tags and the full export block tags to determine how to process the read-modify command. If a line cache line hit occurs (1206), the export block controller performs one or more selected actions (1208) depending on the line state. As FIG. 12 shows, if the line state is Modified, the export block controller sends a probe to the modifying node to forward the data to the requesting node. If the line is Owned, the export block controller sends a probe to the owning node to forward the data to the requesting node, and invalidates all other sharing nodes. If the line state is Shared, the export block controller sends a probe to all nodes on the sharing list of the line to invalidate their copies, and returns the resident data to the requesting node. The export block controller then sets the line state to Modified and sets the modifying node identifier to that of the requesting node (1210).

Otherwise, if a block hit occurs (1212), the export block controller accesses the line state indicated in the cache block tag entry and performs one or more actions (1214) depending on the line state. As FIG. 12 provides, if the line state in the cache block is RemoteInvalid=1 (Modified Locally), the export block controller returns to the requesting node the line from the memory in which it resides. If the line state in the cache block is RemoteInvalid=0 (Shared), the export block controller returns the resident data to the requesting node, and send probes to invalidate the line in the caches in the other nodes on the sharing list for the block. If there is a block and line cache miss, the export block controller returns the resident data to the requesting node (1216), creates a new line cache entry in the line cache, sets the line state to Modified, and sets the modifying node identifier to the requesting node.

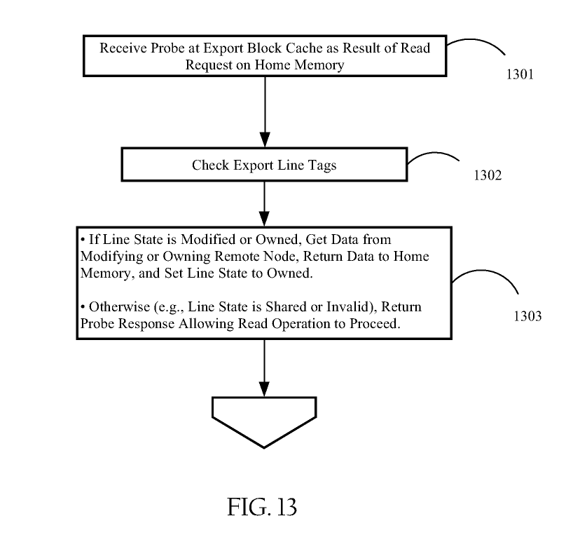

FIG. 13 is a diagram showing a flowchart of an example process for handling a read command's probe at an export block cache, which process might be used with an embodiment of the present invention. As noted in the figure, the probe results from a read request (e.g., RdBlk) to the memory of a home node. In steps 1301 and 1302, the export block controller receives the probe from the memory and checks its export line tags to determine how to proceed in step 1303. If the line state is Modified or Owned, the export block controller (a) gets the data from the remote node (e.g., the node that has the remotely Modified or Owned data, respectively), (b) returns the data to the requester on the home node, and (c) sets the line state to Owned. Otherwise (e.g., if the line state is Shared or Invalid), the export block controller returns a probe response to requester allowing the read operation to proceed.

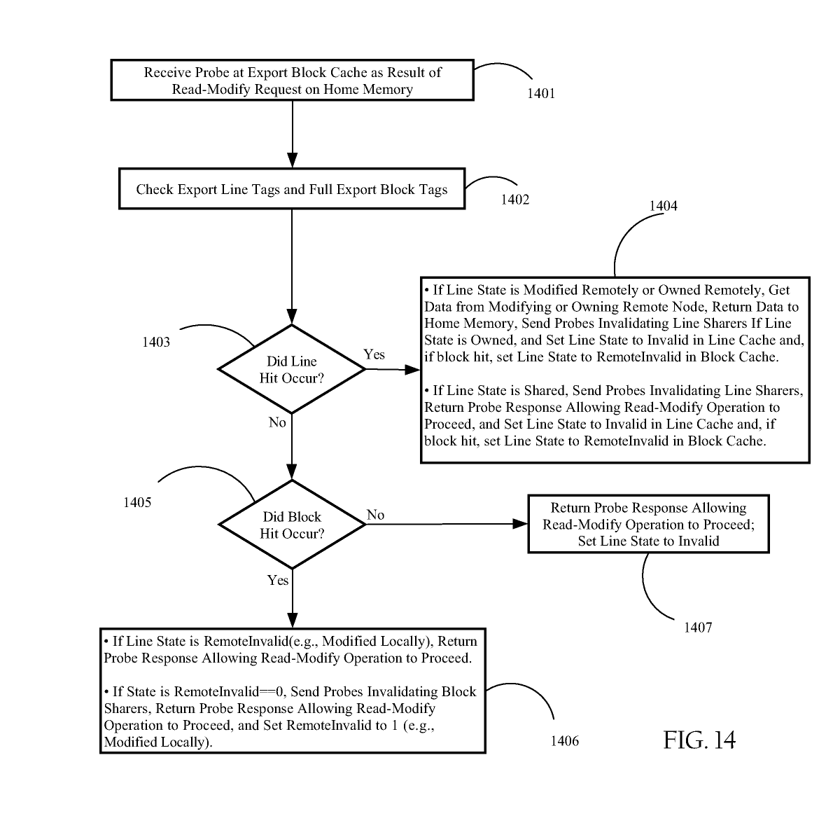

FIG. 14 is a diagram showing a flowchart of an example process for handling a read-modify command's probe at an export block cache, which process might be used with an embodiment of the present invention. Here, it will be appreciated that the export block controller's node is the home node. As noted in the figure, the probe results from a read-modify request (e.g., RdBlkMd) to the memory of a home node. In steps 1401 and 1402, the export block controller receives the probe from the memory and checks its export line tags and full export block tags to make the determinations shown in steps 1403 and 1405. As noted in FIG. 14, those two determinations may occur at the same time, though they are shown sequentially in the figure. In step 1403, the export block controller determines if a line hit has occurred. If so, that implies that the line state is Modified remotely, Owned remotely, or Shared, and the export block controller goes to step 1404. In step 1404, if the line state is Modified or Owned remotely, the export block controller (a) gets the data from the remote node (e.g., the node that has the remotely Modified or Owned data, respectively), (b) returns the data to the memory on the home node, (c) sends invalidating probes to the line sharers, if the line state is Owned, and (d) sets the line state to Invalid in the line cache and, if there is also a block hit, sets the line state to RemoteInvalid=1 in the block cache. If the line state is Shared, the export block controller (a) sends invalidating probes to line sharers, (b) returns a probe response allowing the read-modify operation to proceed, (c) sets the line state to Invalid and in the line cache and, if there is also a block hit, sets the line state to RemoteInvalid=1 in the block cache. In step 1403, if a line hit does not occur, the export block controller determines whether a block hit has occurred, in step 1405. If so, the process goes to 1406. In step 1406, if the line state is RemoteInvalid (e.g., Modified locally), the export block controller returns a probe response allowing the read-modify operation to proceed. If the state is RemoteInvalid==0, the export block controller (a) sends invalidating probes to the block sharers, (b) returns the probe response allowing the read-modify operation to proceed, and (c) sets the line state RemoteInvalid bit to 1 (e.g., Modified locally). If a block hit does not occur in step 1405, that implies that the line state is Invalid and the process goes to step 1407, where the export block controller returns a probe response allowing the read-modify operation to proceed and sets the line state to Invalid.

As noted above, some embodiments use compact block tags rather than full block tags. In such embodiments, many of the steps shown in FIG. 14 remain the same. However, with compact block tags, the determination as to the state of the RemoteInvalid bit might become unnecessary in some embodiments, since the line tag includes a valid entry with an invalid state (RemoteInvalid or Locally Modified) which can be checked during the check for a line hit in step 1404 and the action corresponding to step 1406 can be taken. It will be appreciated that in such embodiments, the export block tag would not include a RemoteInvalid bit indicating whether a line had been Modified locally, but where the RemoteInvalid bit is set to 1, a line entry with such state is allocated.

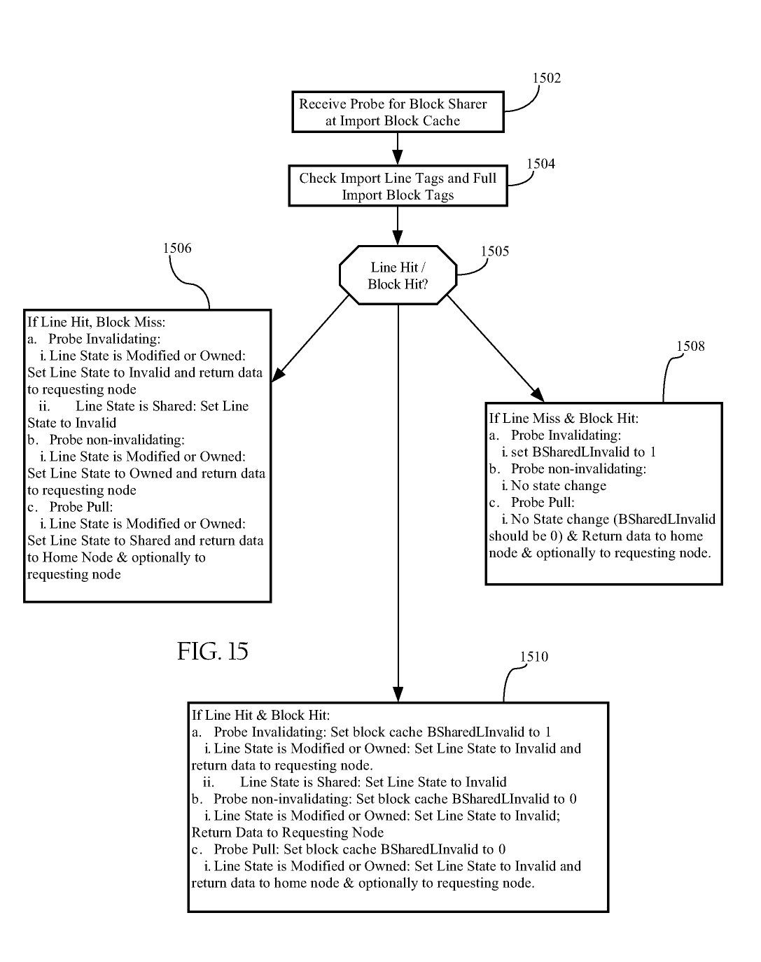

FIG. 15 is a diagram showing a flowchart of an example process for handling a probe for a block sharer at an import block cache, which process might be used with an embodiment of the present invention. In steps 1502 and 1504, the import block controller receives the probe and checks its import line tags and full import block tags (1505) to make the determinations as to how the probe is to be processed. As FIG. 15 illustrates, the import block controller performs one or more actions (1506, 1508, 1510) depending on whether a block hit or line hit occurs, as well as the probe type and line state. If a line hit and a block miss occurs (1506), for invalidating probes, the import block controller sets the line state to Invalid and returns the data to the requesting node, if the line state is Modified or Owned. For non-invalidating probes, the import block controller sets the line state to Owned and returns the resident data to the requesting node, if the lines state is Modified or Owned. For probe pulls, the import block controller sets the line to Shared and returns the data to the home node and, optionally, the requesting node, if the lines state is Modified or Owned.

If there is a line miss and a block hit (1508), the import block controller sets the BSharedLInvalid bit to 1 in response to invalidating probes. No state change occurs for non-invalidating probes, as well as probe pulls. However, the import block controller returns resident data to the home node and (optionally) the requesting node in response to probe pulls.

Lastly, if both a line hit and a block hit occur (1510), the import block controller sets the BSharedLInvalid bit to 1 in response to invalidating probes. Furthermore, if the line state is Modified or Owned, the import block controller sets the line state to Invalid and returns the data to the requesting node. Otherwise, if the line state is Shared, the import block controller sets the line state to Invalid. For non-invalidating probes, the import block controller sets the BSharedLInvalid bit in the block cache tag to 0 and, if the line state is Modified or Owned, sets the line state to Invalid and returns the data to the requesting node. Furthermore, for probe pulls, the import block controller sets the BSharedLInvalid bit in the block cache tag to 0 and, if the line state is Modified or Owned, sets the line state to Invalid and returns the data to the home node and (optionally) the requesting node.

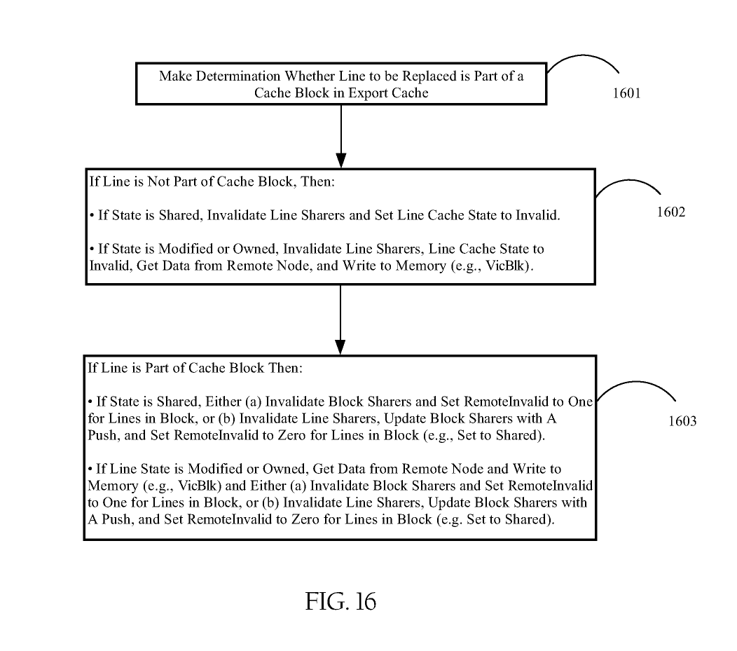

FIG. 16 is a diagram showing a flowchart of an example process for handling a line replacement at an export cache, which process might be used with an embodiment of the present invention. In the process's first step 1601, the export block controller makes a determination whether the line to be replaced is part of a cache block in the export cache, e.g., in conjunction with a capacity miss. If the determination is a block cache miss, the process goes to step 1602. In step 1602, if the state is Shared, the export block controller invalidates the sharers of the line and sets the state of the line in line cache to Invalid). If the line's state is Modified or Owned, the export block controller invalidates the sharers of the line, sets the state of the line in line cache to Invalid), gets the data from the remote node, and writes the data to memory, which is the “home” memory (e.g., in connection with a VicBlk command). If the determination in step 1601 is that the line to be replaced is part of a cache block, the process goes to step 1603. In step 1603, if the state is Shared, the export block controller either (a) invalidates the block sharers and sets the RemoteInvalid bit to one for lines in the block (e.g., sets the lines' state to Invalid) or (b) invalidates the line's sharers, updates the block sharers (e.g., using a push operation), and sets the RemoteInvalid bit to zero for lines in the block (e.g., sets the lines' states to Shared). In step 1603, if the line state is Modified or Owned, the export block controller gets the data from a remote node, writes it to memory (which is the “home” memory), and either (a) invalidates the block sharers and sets the RemoteInvalid bit to one for lines in the block or (b) invalidates the line's sharers, updates the block sharers (e.g., using a push operation), and sets the RemoteInvalid bit to zero for lines in the block.

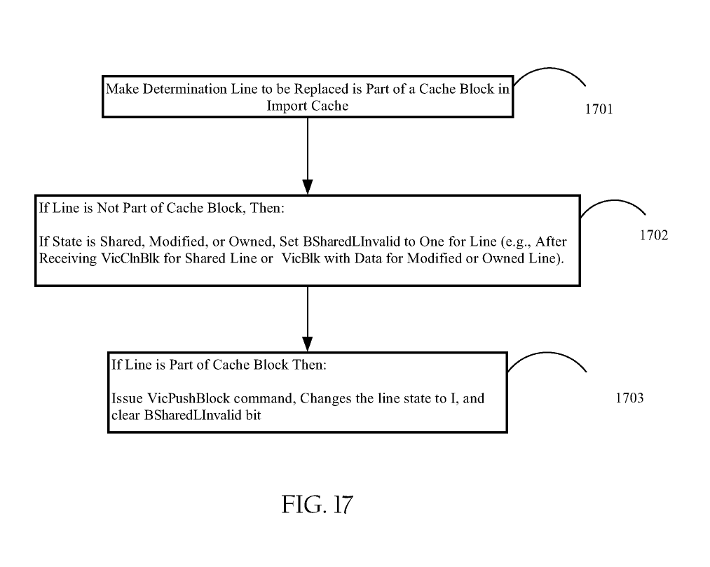

FIG. 17 is a diagram showing a flowchart of an example process for handling a line replacement at an import cache, which process might be used with an embodiment of the present invention. In the process's first step 1701, the import block controller makes a determination as to whether the line to be replaced is part of a cache block. If the line to be replaced is not part of a cache block (block cache miss), the process goes to step 1702. In step 1702, if the line state is Shared, Modified, or Owned, the import block controller invalidates the line by sending appropriate probes to the processors on that node, and transitions to the invalid state after issuing a VicClnBlk (for S case) or VicBlk (updating home node memory in case of M or O) command. In the case of a block hit where the line to be replaced is part of a block cache entry (line state M or O), the process goes to step 1703, where the import block controller issues a VicPushBlock command, changes the line state to I, and clears BSharedLInvalid bit.

Particular embodiments of the above-described processes might be comprised of instructions that are stored on storage media. The instructions might be retrieved and executed by a processing system. The instructions are operational when executed by the processing system to direct the processing system to operate in accord with the present invention. Some examples of instructions are software, program code, firmware, and microcode. Some examples of storage media are memory devices, tape, disks, integrated circuits, and servers. The term “processing system” refers to a single processing device or a group of inter-operational processing devices. Some examples of processing devices are integrated circuits and logic circuitry. Those skilled in the art are familiar with instructions, storage media, and processing systems.

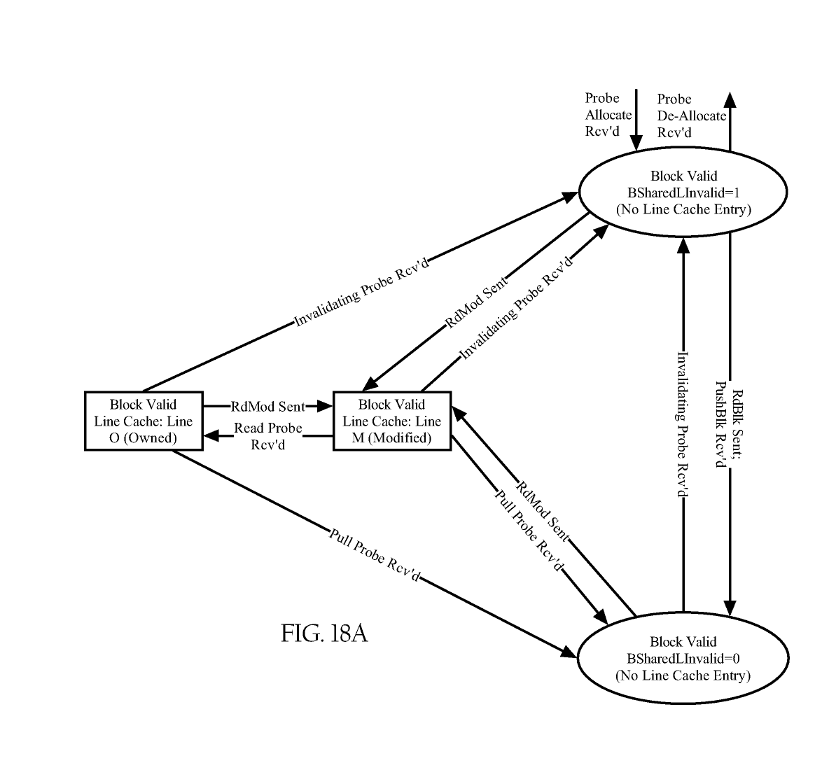

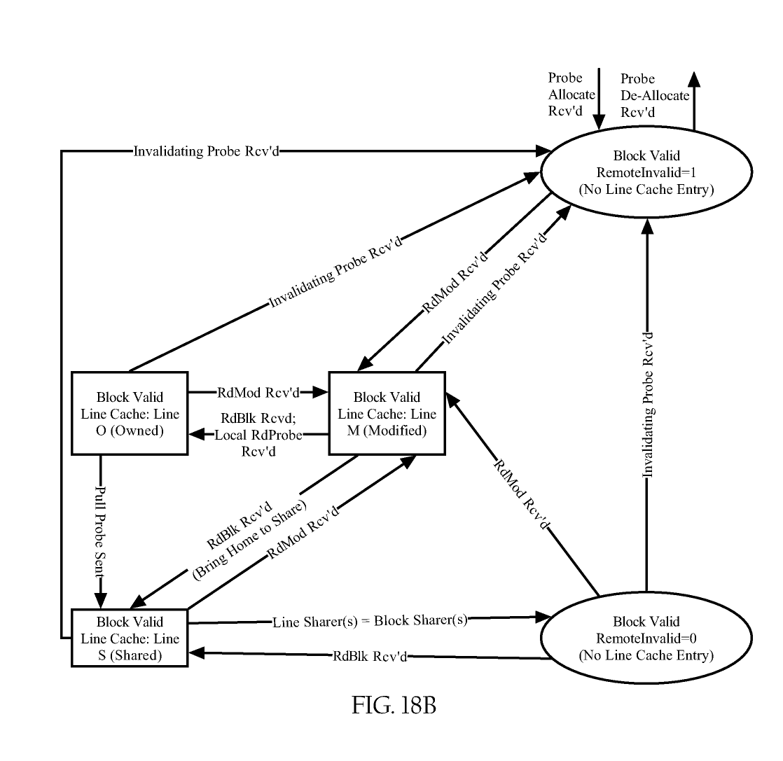

Still further, FIGS. 18A and 18B illustrate line state transitions at import and export block and line caches according to one possible implementation of the invention. The line state transitions discussed herein can occur by implementation of the processes discussed above. States represented in elliptical boundaries indicate that there is no line cache entry for the line, or that such line cache entry is invalid. States represented in rectangular boundaries indicates that a corresponding line cache entry is valid.

FIG. 18A illustrates line state transitions at an import block cache and line cache for a given line that is part of a block cache tag. A pushBlk is a command that causes a given node to send resident data associated with the command to all nodes on the block's sharing list when implementing UOD or UOR (“Update on Demand” or “Update on Replacement”). Further, in the illustrated state diagram, all requests, such as read-modify (RdMod) commands, are sent from the processors local to the node on which the import block controller resides. Invalidating probes in FIG. 18A are received probes transmitted by remote nodes.

When a Probe_Allocate is received, as illustrated in FIG. 6, the import block controller initially sets the BSharedLInvalid bit to 1 for the line. In this state, there is no line cache entry. The line state may transition to Valid/Shared (BSharedLInvalid=0) when a read (e.g., RdBlk) command is sent from the node or a PushBlk command is received. As FIG. 18A illustrates, an invalidating probe causes the line state to transition to BSharedLInvalid=1, and invalidates the line cache entry (if one exists). Transmission of a read-modify (RdMod) command creates a line cache entry to be created with the line state transitioning to Modified (M). Receipt of Pull Probes causes a line state transition to BSharedLInvalid=0, invalidating a line cache entry (if one exists). From the Modified state, receipt of a subsequent Read Probe causes a line state transition to Owned (O).

FIG. 18B shows state transitions for a line at an export block and line cache. On the export side, invalidating probes (Invalidating Probes/Pull Probes) in FIG. 18B refer to probes transmitted by processors that are local to the node in which the export block controller resides, while other commands are requests referring to messages transmitted by remote nodes. Initially, the line state for a line in a block tag is set to RemoteInvalid=1, there is no line cache entry for the line. Receipt of read-modify commands at the export cache causes state transitions (and creation of a line cache entry) for the line to Modified (M). Invalidating probes cause state transitions back to RemoteInvalid=1, invalidating a corresponding line cache entry (if one exists). From the Modified state, receipt of RdBlk commands from remote nodes or a local read probe (RdProbe) from a local processor causes a line state transition to Owned (O). From the Owned state, Pull Probes cause line state transitions to Shared (S). If it is determined that the line sharers corresponding to the line cache entry and the block sharers corresponding to the block cache entry are the same, the export block controller may transition the block cache line state to RemoteInvalid=0 and invalidate the line cache entry. As FIG. 18B provides, a RdBlk command can cause a line transition from RemoteInvalid=0 to creation of an overriding line cache entry with state Shared.

Those skilled in the art will appreciate variations of the above-described embodiments that fall within the scope of the invention. For example, in the embodiments described above, the line state information in the line cache (if an entry exists) overrides line state information in the block cache. In other implementations, however, the state information in the line and block caches could be used in a cooperating manner. For example, since the block and line caches can be accessed concurrently the state information in the line and block caches for a line could be read as a single field. In this regard, it will be appreciated that there are many possible orderings of the steps in the processes described above and many possible modularizations of those orderings. Also, there are many possible divisions of these orderings and modularizations between hardware and software. And there are other possible systems in which block caching might be useful, in addition to the DSM systems described here. As a result, the invention is not limited to the specific examples and illustrations discussed above, but only by the following claims and their equivalents.

What is claimed is:

1. A network node comprising
a home memory operative to store one or more memory blocks, wherein each memory block includes one or more memory lines;
a cache operative to store one or more memory lines from a memory block whose home memory is on a remote network node;
one or more processors;
a block-cache data structure for tracking a cache-coherency state for one or more memory blocks, wherein the data structure includes an entry for each tracked memory block and wherein each entry includes a field that identifies the memory block and a field that indicates a cache-coherency state corresponding to all lines in the memory block;
a line-cache data structure for tracking cache-coherency states of one or more memory lines in a memory block, wherein the line-cache data structure includes an entry for each tracked memory line and wherein each entry includes a field that indicates the cache-coherency state for the memory line; and
a distributed memory logic circuit operatively coupled to the one or more processors and disposed to apply a cache-coherency protocol to memory traffic between the one or more processors and one or more remote network nodes, wherein the distributed memory logic circuit is operative to modify the cache, the block-cache data structure, and the line-cache data structure in accordance with the protocol, in response to memory accesses by the one or more processors or the one or more remote network nodes.

2. The network node of claim 1 wherein an entry in the block cache data structure includes a field that summarizes the cache coherency state with respect to invalidity for a group of memory lines in the memory block.

3. The network node of claim 1 wherein the cache coherency state in the field in the block cache data structure for the memory block that includes the memory line is a default state, and wherein the cache coherency state in the field for a memory line in the line cache data structure takes precedence over the cache coherency state in the field in the block cache data structure for the memory block that includes the memory line.

4. The network node of claim 1 wherein the cache coherency state in the field in the block cache data structure for the memory block that includes the memory line is and the cache coherency state in the field for a memory line in the line cache data structure are used collectively to determine line state.

5. The network node of claim 1 wherein the block-cache data structure comprises an export block-cache data structure for tracking memory blocks exported from the home memory of the node and an import block-cache data structure for tracking memory blocks imported from remote network nodes.

6. The network node of claim 5 wherein the distributed shared memory logic circuit comprises a coherent memory manager operative, in response to a block export command identifying a memory block, to
add an entry for the block to the export block-cache data structure;
add an identifier for one or more remote network nodes to a field in the entry, wherein the one or more remote network nodes will initially share the block;
send initialization messages to the one or more identified nodes to sequentially unmask the lines of the block at those nodes; and
sequentially unmask the lines of the block in the entry in the export block-cache data structure.

7. The network node of claim 5 wherein the distributed shared memory logic circuit comprises a coherent memory manager operative, in response to a block import command identifying a memory block, to
add an entry for the block to the import block-cache data structure;
receive an initialization command, from a remote network node, for a line in the block; and
unmask the line.

8. A distributed shared memory logic circuit in a network node, comprising
a block-cache data structure for tracking cache-coherency states for one or more memory blocks, wherein the data structure includes an entry for each tracked memory block and wherein each entry includes a field that identifies the memory block and a field that indicates a cache-coherency state corresponding to all memory lines in the memory block;
a line-cache data structure for tracking cache-coherency states of one or more memory lines in a memory block, wherein the line-cache data structure includes an entry for each tracked memory line and wherein each entry includes a field that indicates a cache-coherency state for the memory line; and
a coherent memory manager operative to apply a cache-coherency protocol to memory traffic between one or more processors in the node and one or more remote network nodes, wherein the distributed memory logic circuit is operative to modify the block-cache and line-cache data structures, in accordance with the protocol, in response to memory accesses by the one or more processors or the one or more remote network nodes.

9. A method, comprising:
receiving, at a distributed memory logic circuit in a first node in a network, a request from a processor in the first node to read a memory block, wherein the memory block comprises a memory line which line is temporarily stored in a cache at the distributed memory logic circuit and which line is more permanently stored in the memory of a second node in the network;
determining a cache-coherency state for the memory line, wherein the determination of the state depends upon both a line tag for the memory line and a block tag for the memory block that includes the memory line and wherein the line tag and the block tag are maintained by the distributed memory logic circuit;
returning to the first node the cached version of the line, if its cache-coherency state is owned, modified, or shared, wherein the line tag takes precedence over the block tag if the block tag indicates that the cache-coherency state is shared and the line tag indicates that the cache-coherency state is invalid; and
issuing a request for the line to the third node, if the cache-coherency state of the line is invalid;
receiving a copy of the line and transmitting it to the processor and the cache; and
updating the block tag so that the state of the line is shared.

10. The method of claim 9 wherein the block tag includes a state field for the block which state field can be either shared or invalid.

11. The method of claim 9 wherein the line tag includes a state field for the line indicating whether the line is invalid.

12. A method, comprising:
receiving, at a distributed memory logic circuit, a request from a first node in a network to read a memory block, wherein the distributed memory logic circuit is part of a second node in the network and the memory block comprises a memory line which memory line is temporarily stored in a cache at a third node in the network and which memory line is more permanently stored in the memory of the second node;
determining a cache-coherency state for the memory line, wherein the determination of the state depends upon both a line tag for the memory line and a block tag for the memory block that includes the memory line and wherein the line tag and the block tag are maintained by the distributed memory logic circuit;
returning to the first node a copy of the memory line, if the cache-coherency state for the memory line is shared;
issuing a request for the line to the third node, if the cache-coherency state of the memory line is modified or owned by the third node, and adding the first node to a sharing list for the memory line; and
if the cache-coherency state of the memory line is invalid, adding the first node to the sharing list for the memory line, returning to the first node a copy of the memory line, and setting the cache-coherency state of the memory line to shared.

13. The method of claim 12 wherein the block tag includes a state field for the block which state field can be either shared or invalid.

14. The method of claim 12 wherein the line tag includes a state field for the line indicating whether the line is invalid.

15. The method of claim 12, wherein the block tag includes a list of the nodes sharing the memory block that includes the memory line.

16. The method of claim 15 comprising a further step of eliminating the line tag for the memory line if the cache-coherency state of the memory line is shared and the list of nodes sharing the memory line is equal to the list of nodes sharing the memory block.

17. The method of claim 15 wherein a copy of the memory line is returned to the nodes on the block sharing list if the block tag indicates that the cache-coherency state of the memory line is shared.

18. A method, comprising:
receiving, at a distributed memory logic circuit, a request from a first node in a network to read and modify a memory block, wherein the distributed memory logic circuit is part of a second node in the network and the memory block comprises a memory line which line is temporarily stored in a cache at a third node in the network and which line is more permanently stored in the memory of the second node;
determining a cache-coherency state for the memory line, wherein the determination of the state depends upon both a line tag for the memory line and a block tag for the memory block that includes the memory line and wherein the line tag and the block tag are maintained by the distributed memory logic circuit;
if the cache-coherency state for the memory line is shared or modified locally, returning to the first node a copy of the memory line and sending probes to invalidate other nodes on a sharing list for the memory line;
if the cache-coherency state of the memory line is modified remotely or owned, issuing a request for the memory line to the third node and sending probes to invalidate other nodes on the sharing list for the memory line; and
setting the cache-coherency state of the memory line to modified locally, if the cache-coherency state of the memory line is not already modified locally.

19. The method of claim 17, wherein the block tag includes a state field for the block which state field can be either shared or invalid.

20. The method of claim 17, wherein the line tag includes a state field for the line indicating whether the line is invalid.

21. A method, comprising:
receiving, at a distributed memory logic circuit, a probe resulting from a read-modify request on a line of memory, wherein the distributed memory logic circuit is part of a first node in a network and the memory block comprises a memory line which memory line is temporarily stored in a cache at a second node in the network and which memory line is more permanently stored in the memory of the first node;
determining a cache-coherency state for the memory line, wherein the determination of the state depends upon both a line tag for the memory line and a block tag for the memory block that includes the memory line and wherein the line tag and the block tag are maintained by the distributed memory logic circuit;
if the cache-coherency state for the memory line is modified remotely or owned remotely, get a copy of the memory line from the second node, return the copy in response to the probe, and set the cache-coherency state of the memory line to invalid; and
if the cache-coherency state for the memory line is shared, return a probe response allowing the read-modify request to proceed and set the cache-coherency state of the memory line to invalid, if the cache-coherency state is not already invalid.

22. The method of claim 21 wherein the block tag includes a state field for the block which state field can be either shared or invalid.

23. The method of claim 21 wherein the line tag includes a state field for the line indicating whether the line is invalid.

24. The method of claim 21 further comprising the step of sending probes invalidating any nodes on a sharing list for the memory line, if the cache-coherency state of the memory line is owned.

25. The method of claim 21 wherein the block tag includes a list of the nodes sharing the memory block that includes the memory line.

26. The method of claim 25 further comprising the step of sending probes invalidating any nodes on the list of nodes sharing the memory block, if the cache-coherency state of the memory line is shared.

27. A method, comprising:
receiving, at a distributed memory logic circuit in a first node in a network, a probe relating to a memory block, wherein the memory block comprises a memory line which line is temporarily stored in a cache at the distributed memory logic circuit and which line is more permanently stored in the memory of a second node in the network;
determining a cache-coherency state for the memory line, wherein the determination of the state depends upon both a line tag for the memory line and a block tag for the memory block that includes the memory line and wherein the line tag and the block tag are maintained by the distributed memory logic circuit;
if the cache-coherency state for the memory line is modified, owned, or shared and the probe is invalidating, set the cache-coherency state of the memory line to invalid;
if the cache-coherency state for the memory line is modified or owned and the probe is a pull, return a copy of the memory line to a node identified in the probe and set the cache-coherency state of the memory line to shared;
if the cache-coherency state for the memory line is modified and the probe is a read, set the cache-coherency state of the memory line to owned; and
if the cache-coherency state for the memory line is shared and the probe is a push, store the data in the probe in the cache of the memory line and set the cache-coherency state of the memory line to shared.

28. The method of claim 27 wherein the block tag includes a state field for the block which state field can be either shared or invalid.

29. The method of claim 27 wherein the line tag includes a state field for the line indicating whether the line is invalid.

30. The method of claim 27 wherein a copy of the memory line is returned to a node identified in the probe and a second node, if the probe is invalidating and the cache-coherency state of the line is modified or owned.

31. The method of claim 27 wherein a copy of the memory line is returned to a node identified in the probe and the second node, if the probe is a read.

32. Logic encoded in one or more tangible media for execution and when executed operable to:
apply a cache-coherency protocol to memory traffic between one or more processors and one or more remote computing nodes,
maintain a block-cache data structure for tracking a cache-coherency state for one or more memory blocks, wherein the data structure includes an entry for each tracked memory block and wherein each entry includes a field that identifies the memory block and a field that indicates a cache-coherency state corresponding to one or more lines in the memory block;
maintain a line-cache data structure for tracking cache-coherency states of one or more memory lines in a memory block, wherein the line-cache data structure includes an entry for each tracked memory line and wherein each entry includes a field that indicates the cache-coherency state for the memory line; and
modify the cache, the block-cache data structure, and the line-cache data structure in accordance with the protocol, in response to memory accesses by the one or more processors or the one or more remote network nodes.
